(19) United States
(12) Patent Application Publication
(10) Pub. No.: US 2003/0162466 A1
(43) Pub. Date: Aug. 28, 2003

(54) Oven for the heat treatment of glass articles or the like

(76) Inventor: Harold King, Halesowen (GB)

Correspondence Address: BARNES & THORNBURG, 11 SOUTH MERIDIAN, INDIANAPOLIS, IN, 46204

(21) Appl. No.: 10/296,784

(22) PCT Filed: May 31, 2001
(86) PCT No.: PCT/GB01/02437

(30) Foreign Application Priority Data
May 31, 2000 (GB) 00130229

(51) Int. Cl. H01J 9/26

(52) U.S. Cl. 445/25

(57) ABSTRACT

An oven for heat treatment of glass articles, or the like, in particular CRT tubes, comprises an enclosure (38), a fan (48) for driving a flow of air through the enclosure and a radiant heater (64) located within the enclosure. The invention also encompasses a kit for retrofitting into an existing oven and a radiant heater for use in such an oven.

The present invention relates to ovens for the heat treatment of glass articles or the like and particularly to, but not exclusively limited to, ovens for the treatment of cathode ray tube components. Such components are treated either individually in a “lehr” or as an assembly in a tunnel-type oven whilst at the same time evacuating gas within the cathode ray tube assembly. Tunnel-type ovens in which the tubes are evacuated during heat treatment are commonly referred to as “exhaust ovens”

Examples of such exhaust ovens for that purpose are described in our previous UK patent application No. 2300906 and U.S. Pat. No. 4,752,268.

The heating and cooling of glass articles to relieve stresses is called annealing. Glass articles and, particularly, glass cathode ray tube components, are also commonly annealed in a kiln called a “lehr”. It is known that parts of a glass article have different thicknesses and, during heat treatment in a lehr or exhaust oven, will absorb heat through the glass unevenly so that thicker parts will reach a set temperature slower than thinner parts. Uneven heating or uneven heat distribution within the article can damage the glass and even cause breakages.

The heating and cooling of a shaped gas envelope forming the cathode ray tube in an exhaust oven during evacuation subjects the walls of the tube to substantial external pressure and is therefore a critical operation. The demand for ever larger and flatter cathode ray tubes, particularly for domestic high definition “true flat screen” television receivers has increased the processing problems and the need for ovens designed to give economical production and minimum damage or wastage of these high value components.

Existing exhaust ovens such as described in GB2300906 work well but rely mainly upon forced convection air currents to transfer heat into the glass. There is no significant radiant heat emitted from the internal surfaces of the oven which would affect the heating of the glass. Convection heat travels relatively slowly through glass and other materials and so different areas of different thicknesses in the glass or other material will heat up at different rates.

Glass articles with cross-sectional areas of substantially different thicknesses, for example cathode ray tubes where the corners in a cathode ray tube are generally thicker than the side walls and face or screen of the tube, can suffer from wide-ranging temperature variations between points of different thicknesses on the same article. Those temperature differences can lead either to slower production rates where a manufacturer reduces the rate of through put of cathode ray tubes through the tunnel in order to allow time for the article to attain a uniform temperature throughout or to retention of stresses in the glass which could damage the glass and, in the case of cathode ray tubes in an exhaust oven, implosion of the cathode ray tubes.

With the most modern “true flat screen” cathode ray tube designs, the thickness of certain parts of the glass is substantially greater than the rest of the glass which makes temperature differentials, stress retention and product loss much more prevalent in these components.

It is an object of the present invention to provide an improved oven for the heat treatment of glass articles and the like.

According to one aspect of the invention there is provided an oven for the heat treatment of glass articles or the like comprising an enclosure within the oven for receiving a glass article or the like, means for providing a flow of heated air through the enclosure, and a radiant heat source located within the enclosure.

In that way, the present invention provides means which is particularly effective and reliable in operation for reducing the temperature differentials across different parts of the glass article. More particularly, it increases the amount of heat supplied to the corners of the cathode ray tube and ensures that the glass in the thicker parts of the tube is heated quickly and evenly at a more similar rate to the rest of the glass in the thinner parts of the tube.

A plurality of radiant heat sources may be provided within the enclosure. In such a case, each radiant heat source may be arranged close to the glass article, in use. The or each radiant heat source is preferably located adjacent the thicker parts of the glass article.

The radiant heat source may have a shape arranged to conform to the part of the surface of the glass article adjacent which it is located.

The radiant heat source is preferably controlled to ensure control means of local heating of the article. The control of the radiant heat source is preferably effected by pulsing of the radiant heat source on and off to coincide with the arrival of the glass article adjacent to it.

The radiant heat source is preferably an infrared radiant heat source.

The enclosure is preferably a tunnel. The oven is preferably of the type described above, i.e. an exhaust oven.

The glass article is preferably a cathode ray tube.

According to another aspect of the invention there is provided a radiant heat source for use in the oven mentioned above.

According to a further aspect of the invention there is provided a kit for retrofitting to an existing oven comprising a radiant heat source arranged to be located within an enclosure in the oven, the radiant heat source being dimensioned so as to be located close to glass articles in use.

Radiant heat conducts through glass more quickly than convention heat and so the present invention allows for the thickness change in the glass tube or article to be compensated for and hence for production to be faster and/or for less breakages and damage to glass articles to occur.

Embodiments of the invention will now be described in detail by way of example and with reference to the accompanying drawings, in which;

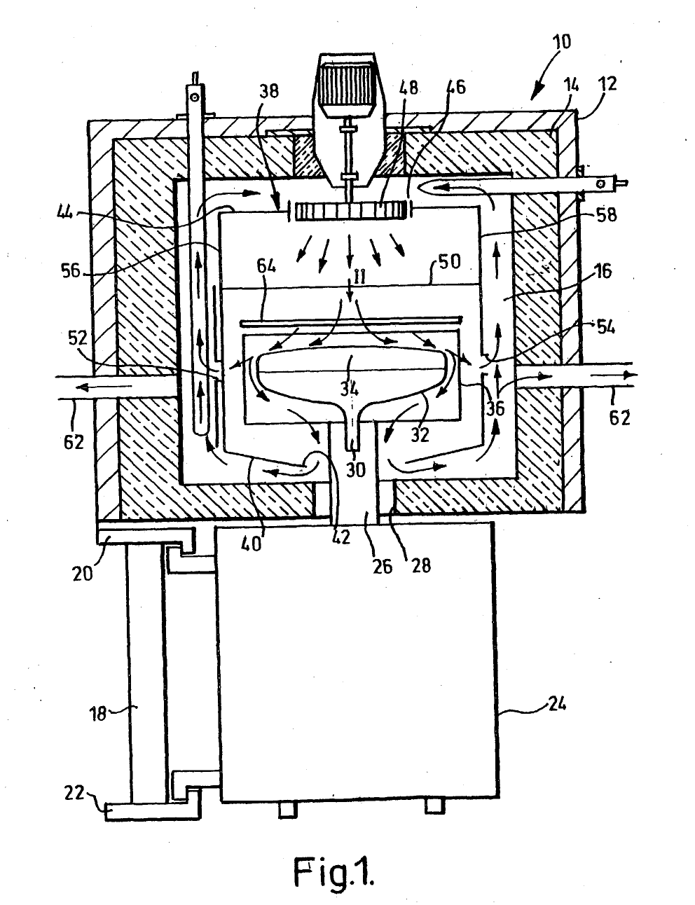

FIG. 1 is a cross-sectional view through an oven in accordance with the invention,

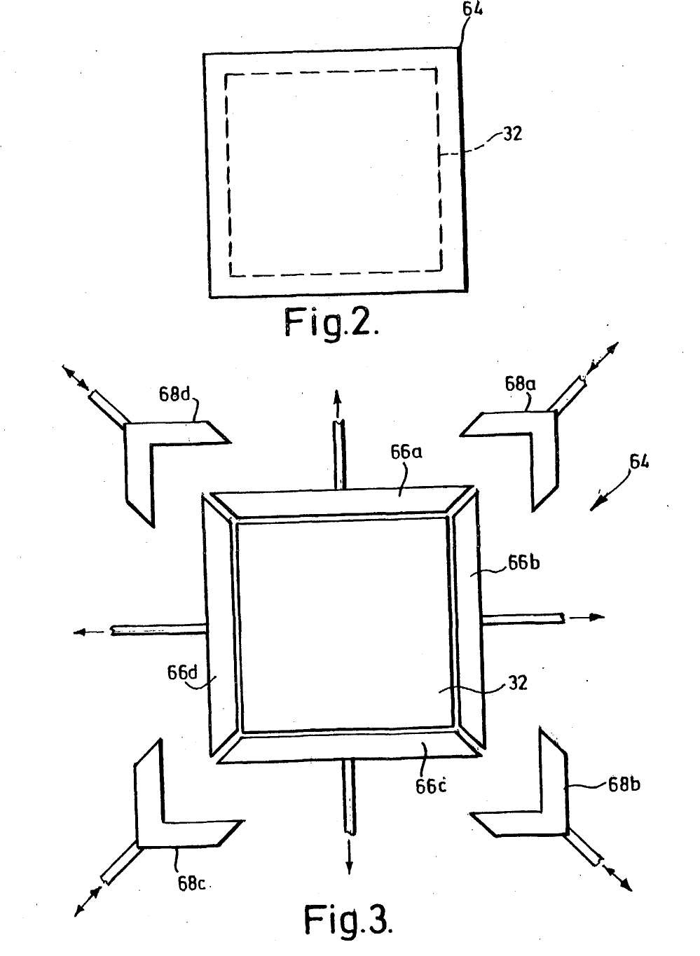

FIG. 2 is a plan view of the radiant heater part of the oven of FIG. 1 looking in the direction of arrow II in FIG. 1, and

FIG. 3 is a plan view of a further arrangement of radiant heat sources in accordance with another embodiment of the invention.

In FIG. 1 an exhaust oven, typically for processing large “flat screen” and other cathode ray tubes, has a tunnel structure 10 having outer structural walls 12 lined with insulating material 14 to define a through passage 16 for passage of the cathode ray tubes.

A track 18 having vertically spaced upper and lower guide rails 20, 22 is located beneath the tunnel structure 10 and extends in a continuous loop from the tunnel exit to the tunnel entrance (not shown).

A train of vacuum carts 24 runs on track 18, each cart being provided with an upwardly projecting support 26 which projects into the bottom part of passage 16 through a longitudinal slot 28 in the floor of the tunnel structure 10. Each support 26 incorporates an exhaust duct and is operatively connected to the neck 30 of the glass envelope of a cathode ray tube 32. The cathode ray tube 32 is transported along passage 16 by movement of the cart 24. The tube 32 is arranged so that the large area screen panel 34 thereof is directed upwards and is maintained substantially centrally of the passage towards the lower part thereof Each cathode ray tube 32 is further supported by a cage 36.

During transport through the oven, vacuum carts 24 are operated automatically in known manner to exhaust the interior of each cathode ray tube 32. The cathode ray tubes for processing are mounted on respective carts 24 at a loading station (not shown) and are dismounted after processing at an unloading station (not shown).

At the same time that the interior of the cathode ray tube 32 is being exhausted, the exterior is heat treated within the oven.

Each cathode ray tube 32 travels in a respective cage 36 for protection and safe support but without any substantial restriction in airflow to and from the exterior of the cathode ray tube 32 itself.

A baffle arrangement 36 is arranged within and spaced from the interior walls of tunnel structure 10 so as to form an inner longitudinal enclosure surrounding but spaced from cages 36 as they and cathode ray tubes travel therethrough. The baffle arrangement 36 has a floor 40 having a continuous central slot 42 just wide enough to allow passage of the support 26. The baffle arrangement 38 has a roof 44 defining a plurality of circular inlet openings 46 (one shown). Each circular inlet opening 46 receives a motor driven fan impeller 48 for driving a flow of air downwardly into the enclosure.

A diffusion screen or other distributive device 50 is provided in the upper region of the baffle arrangement 38 between the roof 44 and the top of the cage 36. Outlet openings 52, 54 are defined in respective side walls 56, 58 of the baffle arrangement 38 along the length thereof, the openings being fitted with dampers or other means of adjusting their effective aperture and/or effective vertical or other positioning in the respective side walls.

The outlet openings 52, 54 are set to be substantially on a level with side edges of the screen panel 34 of cathode ray tube 32. Gas fuelled radiant tube heaters 60 are located in the spaces between the exterior of the baffle arrangement 38 and the inner faces of the insulation 14 lining the walls 12 of the tunnel structure 10. Exhaust ducts 62 are provided in side walls of the tunnel structure 10. In use, hot air is driven in a down flow by fan impeller 48 so that it impinges directly on the panel 34 of the cathode ray tube 32, spreading thereover as indicated by the arrows in FIG. 1 to flow around its edges so that it is substantially evenly heated. A substantial portion of the air flow is drawn from the region to the side edges of the panel to exit through outlet openings 52, 54. A small proportion of the flow passes downwardly towards the neck of the tube so that that part of the envelope of the CRT which is particularly liable to failure is more gently heated. The further downflow is drawn through slot 42 to recirculate around the outside of the baffle arrangement 38 under the action of the fan impellers 48. Surplus heated air is drawn off via exhaust duct 62.

A radiant heating member 64 is arranged within the baffle arrangement 38 beneath the diffusion screen and directly above the upper part of cage 36. The radiant heater 64 is directed so as to radiate infrared heat energy towards the surface of the cathode ray tube 32. Since the thickness of the glass of the cathode ray tube 32 varies quite widely in the edge sections of the screen 34, the radiant heater 64 provides supplementary heating to the cathode ray tube 32 and in particular to those thicker parts of the cathode ray tube 32 which, under normal operation of the oven, would not attain the same temperature as the thinner parts of the cathode ray tube 32. By providing the radiant heater 64 within the enclosure directed towards the cathode ray tube, temperature differentials in the cathode ray tube 32 and thus the possibility of stress retention in the cathode ray tube 32 are substantially lessened.

FIG. 2 is a plan view of the radiant heater 64 shown in FIG. 1. In FIG. 2 it can be seen that the radiant heater 64 comprises a substantially rectangular radiant heating apparatus which is larger in area than the flat part 34 of the cathode ray tube 32. In that way, the whole screen 34 of the cathode ray tube 32 is subjected to the direct annealing process of the infrared heat radiation.

As mentioned previously, radiant heat energy travels through the glass of the cathode ray tube much quicker than the heat from the hot air circulating assembly. In that way, the thicker areas of glass on the cathode ray tube are annealed without inducing stress concentrations or slowing the production process in any way.

FIG. 3 shows an alternative form of radiant heater 64. In FIG. 3 the radiant heater 64 comprises four side parts 66a, b, c, d, each of which are moveable in and out with respect to the oven and corner pieces 68a, b, c, d which are also moveable in and out with respect to the oven. In the position shown in FIG. 3, the four side parts 66a, b, c, d are located inwardly of the corner parts and the opposite edges of the radiant heater side parts 66a, b, c, d are closely adjacent to each other so as to define a rectangle. The radiant heater parts 66a, b, c, d are arranged such that the radiant heat energy from the respective parts is directed towards the outer edges of the screen 34 of the cathode ray tube 32. Those edges are generally thicker than any other part of the glass on a cathode ray tube and so directing the energy specifically to those edges tailors the specific heating arrangement to the article being heated.

Optionally, the side parts 66a, b, c, d can be withdrawn so that respective corner parts 66a, b, c, d are arranged therebetween as shown in broken lines in FIG. 3 between corner parts 66a, b and c. In that way, a larger rectangle can be defined so as to treat optionally a larger cathode ray tube. In that way a single device can be arranged to heat treat multiple sizes of cathode ray tube device.

In operation, the radiant heat source may be left on continuously or it may be pulsed on and off to coincide with the arrival of a new cathode ray tube directly below it as the cathode ray tubes travel along on their exhaust carts.

Where multiple heating zones are provided throughout the length of the tunnel, for example, to provide areas of different temperature within the tunnel, the radiant heat source may be used in any one zone alone or a number of such radiant heaters may be provided in respective heating zones of the exhaust oven so as to form a continuum of edge/corner heating sources along the length of the oven. Each heater is preferably controlled by a temperature control means to ensure optional and controlled heat impute into the edges/corners of the articles.

The present invention increases the amount of heat taken into the corners of glass articles such as a cathode ray tube and ensures that the glass in the thicker parts of the tube is heated quickly and evenly at a more similar rate to the rest of the glass in the thinner parts of the tube due to the convective heating.

1. An oven for the heat treatment of glass articles or the like comprising an enclosure within the oven for receiving a glass article or the like, means for providing a flow of heated air through the enclosure, and a radiant heat source located within the enclosure.

2. An oven for the heat treatment of glass articles or the like according to claim 1 in which a plurality of radiant heat sources is provided within the enclosure.

3. An oven for the heat treatment of glass articles or the like according to claim 2 in which each radiant heat source is arranged close to the glass article, in use.

4. An oven for the heat treatment of glass articles or the like according to claim 1 or 3 in which the or each radiant heat source is located adjacent the thicker parts of the glass article, in use.

5. An oven for the heat treatment of glass articles or the like according to any preceding claim in which the or each radiant heat source has a shape arranged to conform to the part of the surface of the glass adjacent which it is located.

6. An oven for the heat treatment of glass articles or the like according to any preceding claim in which the or each radiant heat source is controlled to ensure control of local heating.

7. An oven for the heat treatment of glass articles or the like according to claim 6 in which control of the radiant heat source is effected by pulsing of the radiant heat source on and off to coincide with the arrival of the glass article adjacent to it.

8. An oven for the heat treatment of glass articles or the like according to any preceding claim in which the radiant heat source is an infrared radiant heat source.

9. An oven for the heat treatment of glass articles or the like according to any preceding claim in which the enclosure is a tunnel.

10. An oven for the heat treatment of glass articles or the like according to any preceding claim in which the glass article is a cathode ray tube.

11. An oven for the heat treatment of glass articles or the like according to any preceding claim in which the radiant heat source has a first configuration for treatment of articles of one size and a second configuration for treatment of articles of another, different size.

12. An oven for the heat treatment of glass articles or the like according to claim 11 in which the radiant heat source comprises a first radiant heater for use in the first configuration and a second radiant heater for use in combination with the first in the second configuration.

13. A radiant heat source for use in an oven according to any preceding claim.

14. A kit for retrofitting to an existing oven comprising a radiant heat source arranged to be located within an enclosure in the oven, the radiant heat source being dimensioned so as to be located close to glass articles in use.
